(19) United States
(12) Patent Application Publication
(10) Pub. No.: US 2026/0126610 A1
(43) Pub. Date: May 7, 2026

(54) ACTUATOR FOR CAMERA

(71) Applicant: SAMSUNG ELECTRO-MECHANICS CO., LTD., Suwon-si (KR)

(72) Inventors: Deok Hyun LEE, Suwon-si (KR); Kyung Hun LEE, Suwon-si (KR); Jae Hyung HAN, Suwon-si (KR)

(73) Assignee: SAMSUNG ELECTRO-MECHANICS CO., LTD., Suwon-si (KR)

(21) Appl. No.: 19/339,766

(22) Filed: Sep. 25, 2025

(30) Foreign Application Priority Data
Jun. 17, 2025 (KR) 10-2025-0079802
Nov. 4, 2024 (KR) 10-2024-0154669

(51) Int. Cl. G02B 7/08; G02B 27/64

(52) U.S. Cl. CPC G02B 7/08; G02B 27/646

(57) ABSTRACT

An actuator for camera includes a housing having an internal space, a first carrier accommodated in the housing, and a first driving unit including a first magnet disposed in the first carrier, a first coil disposed to face the first magnet in a first-axis direction, and a first position sensor configured to sense a position of the first carrier, wherein the first coil includes a first sub-coil and a second sub-coil spaced apart from each other in a second-axis direction perpendicular to the first-axis direction, a length in the second-axis direction of the first sub-coil is longer than a length in the second-axis direction of the second sub-coil, and the first position sensor is disposed in a position spaced apart from a center of the first sub-coil in the second-axis direction.

### CROSS-REFERENCE TO RELATED APPLICATIONS

This application claims the benefit under 35 USC 119(a) of Korean Patent Application No. 10-2025-0079802 filed on June 17, 2025, in the Korean Intellectual Property Office and Korean Patent Application No. 10-2024-0154669 filed on November 4, 2024, in the Korean Intellectual Property Office, the entire disclosures of which are incorporated herein by reference for all purposes.

### BACKGROUND

### 1. Field

The present disclosure relates to an actuator for camera.

### 2. Description of the Background

Recently, a camera module has been adopted in mobile devices such as a smartphone, a tablet PC, and a laptop.

Also, a camera module may include an actuator having a focusing function and an image stabilization function to generate high-resolution images.

For example, focusing may be performed by moving a lens module in an optical axis (Z-axis) direction, or image stabilization may be performed by moving a lens module in a direction perpendicular to the optical axis (Z-axis).

However, as camera module performance has improved, a weight of a lens module has also increased. Also, as a weight of a driver used to move lens module is also included, it may be difficult to precisely control driving force for focusing and image stabilization.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an actuator for camera includes a housing having an internal space, a first carrier accommodated in the housing, and a first driving unit including a first magnet disposed in the first carrier, a first coil disposed to face the first magnet in a first-axis direction, and a first position sensor configured to sense a position of the first carrier, wherein the first coil includes a first sub-coil and a second sub-coil spaced apart from each other in a second-axis direction perpendicular to the first-axis direction, wherein a length in the second-axis direction of the first sub-coil is longer than a length in the second-axis direction of the second sub-coil, and wherein the first position sensor is disposed in a position spaced apart from a center of the first sub-coil in the second-axis direction.

A position in the second-axis direction of the first position sensor may be between a center of the first sub-coil and a center of the second sub-coil.

A surface of the first magnet facing the first coil may have a first polarity and a second polarity spaced apart from each other in the second-axis direction, the first polarity and the second polarity may be opposite polarities, and the first polarity may face the first sub-coil, and the second polarity may face the second sub-coil.

A length in the second-axis direction of the first polarity may be longer than a length in the second-axis direction of the second polarity, and the first position sensor may face a portion of the first magnet spaced apart from a center of the first polarity in the second-axis direction.

A position in the second-axis direction of the first position sensor may be between a center of the first polarity and a center of the second polarity.

When viewed in the first-axis direction, a center in the second-axis direction of a side surface of the first carrier, on which the first magnet is disposed, may overlap the first position sensor.

The actuator may further include a first ball member disposed between the housing and the first carrier, wherein a guide groove in which the first ball member is disposed may be disposed on at least one of a surface of the housing and a surface the first carrier, facing each other in a direction perpendicular to both the first-axis direction and the second-axis direction.

The first driving unit may include a second magnet disposed on the first carrier, a second coil disposed to face the second magnet, and a second position sensor configured to sense a position of the first carrier, and the second coil may include a third sub-coil and a fourth sub-coil spaced apart from each other in the first-axis direction.

The second position sensor may include a plurality of hall sensors spaced apart from each other in the first-axis direction.

The first magnet and the first coil may be configured to generate driving force in a direction in which the first magnet and the first coil face each other, and the second magnet and the second coil may be configured to generate driving force in a direction in which the second magnet and the second coil face each other.

The actuator may further include a second carrier accommodated in the first carrier, and an image sensor fixed to the second carrier and including an imaging plane, wherein the first carrier and the second carrier may be configured to move together in the first-axis direction and the second-axis direction, and the second carrier may be configured to move relative to the first carrier in an optical-axis direction perpendicular to both the first-axis direction and the second-axis direction.

A first yoke may be disposed in the housing to face the first magnet and the second magnet in a direction perpendicular to the imaging plane.

The actuator may further include a second driving unit including a third magnet disposed in the first carrier and a third coil disposed in the second carrier, wherein a substrate may be disposed in the second carrier, and the third coil may be disposed on a surface of the substrate.

The second magnet and the third magnet may be disposed between the second coil and the third coil.

Other features and aspects will be apparent from the following detailed description, the drawings, and the claims.

### BRIEF DESCRIPTION OF DRAWINGS

FIG. 1 is a perspective diagram illustrating a camera module according to an embodiment of the present disclosure.

FIG. 2 is a cross-sectional diagram illustrating a camera module according to an embodiment of the present disclosure.

FIG. 3 is an exploded perspective diagram illustrating a camera module according to an embodiment of the present disclosure.

FIG. 4 is an exploded perspective diagram illustrating a housing, a first carrier and a first driver according to an embodiment of the present disclosure.

FIG. 5 is a diagram illustrating a housing according to an embodiment of the present disclosure, viewed from below.

FIG. 6 is a plan diagram illustrating a state in which components illustrated in FIG. 4 are coupled to each other.

FIG. 7 is a cross-sectional diagram taken along line I-I’ in FIG. 6.

FIG. 8 is a perspective diagram illustrating a first driver according to an embodiment of the present disclosure.

FIG. 9 is a plan diagram illustrating a state in which a case is removed from a camera module according to an embodiment of the present disclosure.

FIGS. 10A, 10B, and 10C are diagrams illustrating the effect of rotation of a second carrier on position sensing of the second carrier.

FIGS. 11, 12, and 13 are diagrams illustrating modified examples of a first magnet and a first coil of first driver.

FIG. 14 is a plan diagram illustrating a sensor substrate of an actuator according to an embodiment of the present disclosure.

FIG. 15 is a cross-sectional diagram taken along line II-II’ in FIG. 14.

FIG. 16 is an exploded perspective diagram illustrating a first carrier, a second carrier and a second driver according to an embodiment of the present disclosure.

FIG. 17 is a perspective diagram illustrating the example illustrated in FIG. 16 in a different direction.

FIG. 18 is a diagram illustrating a second carrier, viewed from the side.

FIGS. 19, 20, and 21 are exploded perspective diagrams illustrating a camera module according to another embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An embodiment of the present disclosure is to provide an actuator for camera which may improve image stabilization performance.

A camera module according to embodiments may be mounted on a portable electronic device. The portable electronic device may include a mobile communication terminal, a smartphone, or a tablet PC.

In embodiments, the direction in which an imaging plane of the image sensor S faces may be an optical axis (Z-axis) direction.

In embodiments, moving the image sensor S in a direction parallel to the imaging plane of the image sensor S may indicate moving the image sensor S in a direction perpendicular to the optical axis (Z-axis).

The first axis (X-axis) direction and the second axis (Y-axis) direction may be perpendicular to the optical axis (Z-axis) and may intersect each other.

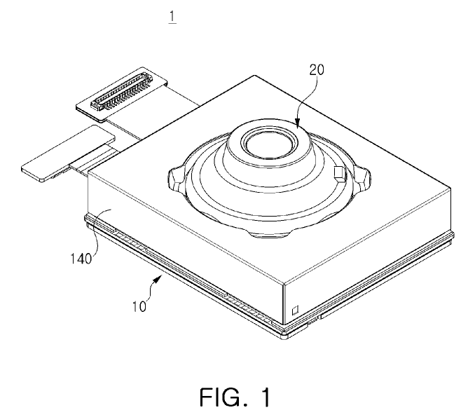

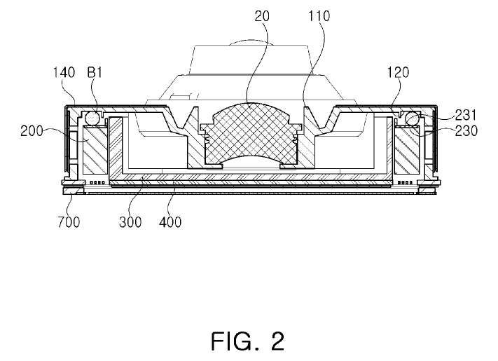

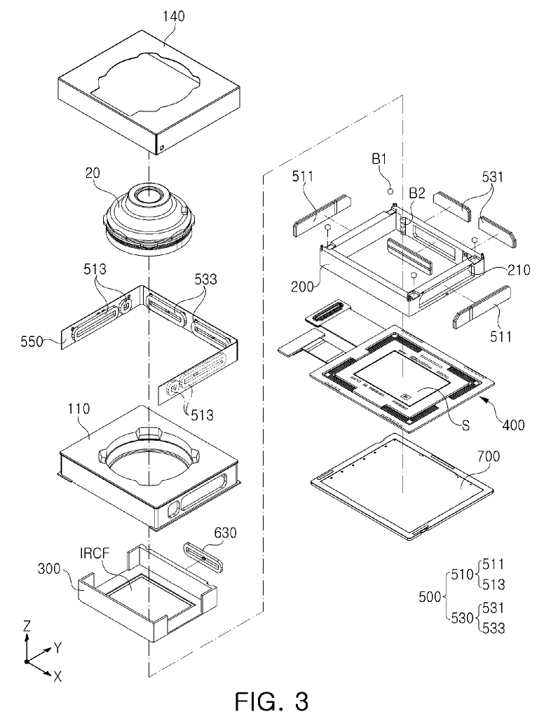

FIG. 1 is a perspective diagram illustrating a camera module according to an embodiment. FIG. 2 is a cross-sectional diagram illustrating a camera module according to an embodiment. FIG. 3 is an exploded perspective diagram illustrating a camera module according to an embodiment.

Referring to FIGS. 1 to 3, a camera module 1 according to an embodiment may include a lens module 20 and an actuator 10 for camera (hereinafter, referred to as an “actuator”).

The lens module 20 may include one or more lenses and a lens barrel. One or more lenses may be disposed in the lens barrel. When a plurality of lenses are provided, the plurality of lenses may be disposed in the lens barrel along the optical axis (Z-axis).

The lens module 20 may be coupled to a housing 110. The housing 110 may have a quadrangular box shape having a hollow portion penetrated in the optical axis (Z-axis) direction, and the lens module 20 may be inserted into the hollow portion of the housing 110 and may be fixed to the housing 110.

In an embodiment, the lens module 20 may be a fixed member fixed to the housing 110. For example, the lens module 20 may be a fixed member not moving during autofocus AF and image stabilization OIS.

According to an embodiment, the camera module 1 may perform autofocus AF and image stabilization OIS by moving the image sensor S instead of the lens module 20. By moving the image sensor S having a relatively light weight, the image sensor S may move with reduced driving force. Accordingly, components included in the actuator 10 may be miniaturized.

The actuator 10 may include a housing 110, a first carrier 200, and a second carrier 300.

The first carrier 200 may be accommodated in the housing 110 and may move in the direction perpendicular to the optical axis (Z-axis) with respect to the housing 110. That is, the first carrier 200 may be a fixed member not moving in the optical axis (Z-axis) direction during focusing, but may be a moving member moving in the direction perpendicular to the optical axis (Z-axis) during image stabilization.

The second carrier 300 may be accommodated in the first carrier 200 and may move in the optical axis (Z-axis) direction relative to the first carrier 200. Since the second carrier 300 is constrained to not move relative to the first carrier 200 in the direction perpendicular to the optical axis (Z-axis), when the first carrier 200 moves in the direction perpendicular to the optical axis (Z-axis), the second carrier 300 may move in the direction perpendicular to the optical axis (Z-axis) together with the first carrier 200.

The image sensor S may be fixed to the second carrier 300 to move together with the second carrier 300.

Accordingly, the image sensor S may move in the optical axis (Z-axis) direction with the second carrier 300 to focus, and the image sensor S may move along with the second carrier 300 in the direction perpendicular to the optical axis (Z-axis) to perform image stabilization during imaging.

An infrared cut filter (IRCF) may be mounted on the second carrier 300.

The actuator 10 may further include a case 140. The case 140 may be coupled to the housing 110 and may protect internal components of the actuator 10.

The image sensor S may be mounted on the sensor substrate 400. A portion of the sensor substrate 400 may be coupled to the second carrier 300, and the other portion of the sensor substrate 400 may be coupled to the housing 110.

An image sensor S may be mounted on a portion of the sensor substrate 400 coupled to the second carrier 300.

Since a portion of the sensor substrate 400 is coupled to the second carrier 300, as the second carrier 300 moves, a portion of the sensor substrate 400 may also move together with the second carrier 300.

Accordingly, the image sensor S may move in the optical axis (Z-axis) direction to focus, and may move in the direction perpendicular to the optical axis (Z-axis) to perform image stabilization during imaging.

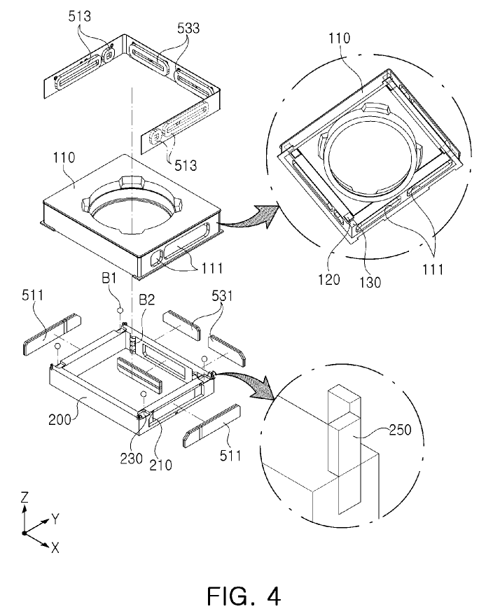

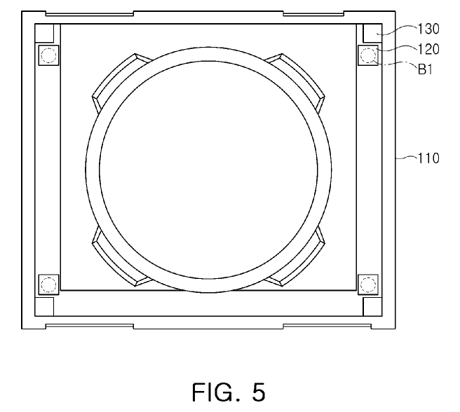

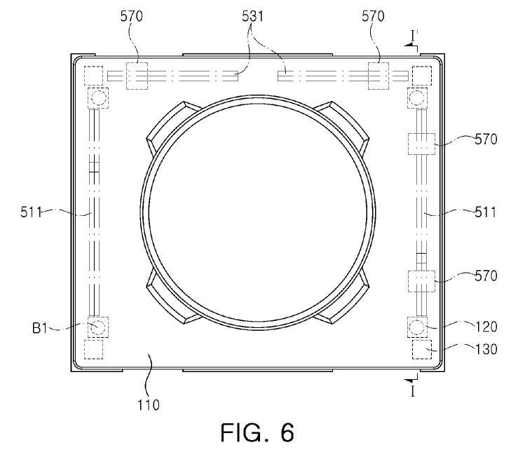

FIG. 4 is an exploded perspective diagram illustrating a housing, a first carrier and a first driver according to an embodiment. FIG. 5 is a diagram illustrating a housing according to an embodiment, viewed from below. FIG. 6 is a plan diagram illustrating a state in which components illustrated in FIG. 4 are coupled to each other.

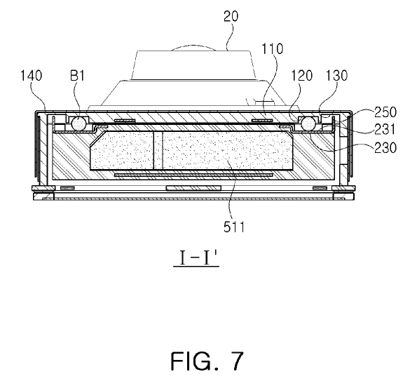

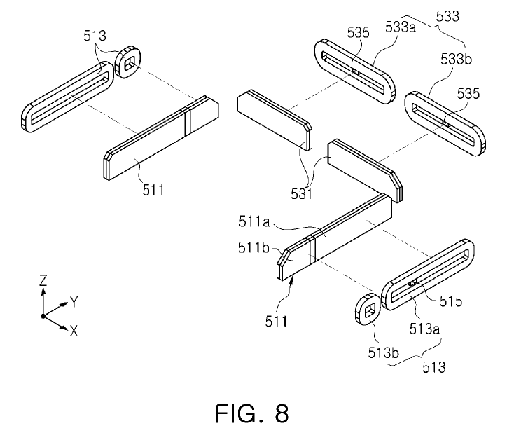

FIG. 7 is a cross-sectional diagram taken along line I-I’ in FIG. 6. FIG. 8 is a perspective diagram illustrating a first driver according to an embodiment.

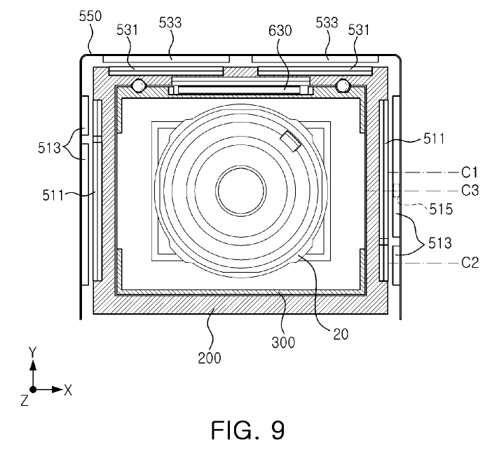

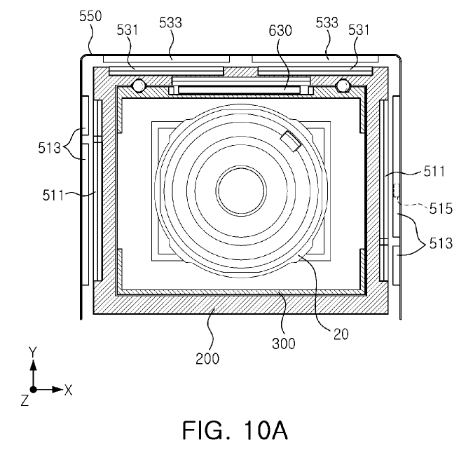

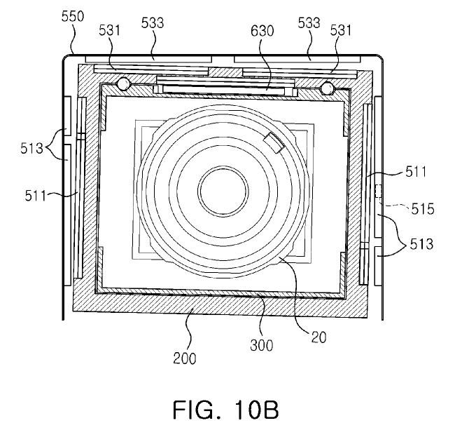

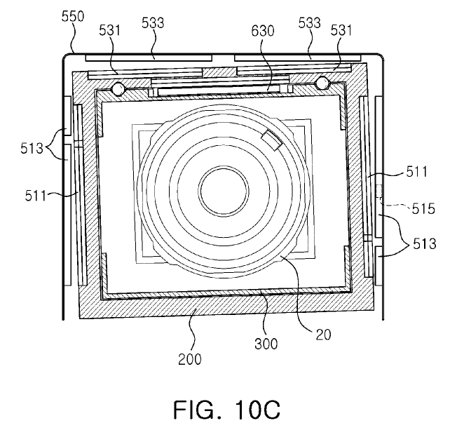

FIG. 9 is a plan diagram illustrating a state in which a case is removed from a camera module according to an embodiment. FIGS. 10A, 10B, and 10C are diagrams illustrating the effect of rotation of a second carrier on position sensing of the second carrier.

Referring to FIGS. 4, 5, 6, 7, 8, and 9, a first carrier 200 may be disposed in a housing 110. In the housing 110, the first carrier 200 may move relative to the housing 110 in the first axis (X-axis) direction and the second axis (Y-axis) direction.

The first axis (X-axis) direction may be the direction perpendicular to the optical axis (Z-axis), and the second axis (Y-axis) direction may be a direction perpendicular to both the optical axis (Z-axis) direction and the first axis (X-axis) direction.

An actuator 10 according to an embodiment may include a first driving unit 500. The first driving unit 500 may move the first carrier 200 in the direction perpendicular to the optical axis (Z-axis) by generating driving force perpendicular to the optical axis (Z-axis).

The first driving unit 500 may include a first image-stabilization driving unit 510 and a second image-stabilization driving unit 530. The first image-stabilization driving unit 510 may generate driving force in the first axis (X-axis) direction, and the second image-stabilization driving unit 530 may generate driving force in the second axis (Y-axis) direction.

The first image-stabilization driving unit 510 may include a first magnet 511 and a first coil 513. The first magnet 511 and the first coil 513 may be disposed to face in the direction perpendicular to the optical axis (Z-axis).

The first magnet 511 may be disposed in the first carrier 200. For example, the first magnet 511 may be mounted on a side surface of the first carrier 200. A mounting groove 210 in which a first magnet 511 is mounted may be provided on a side surface of the first carrier 200. By inserting the first magnet 511 into the mounting groove 210, an increase in the sizes of the actuator 10 and the camera module 1 due to the thickness of the first magnet 511 may be prevented.

The first magnet 511 may include one or a plurality of magnets.

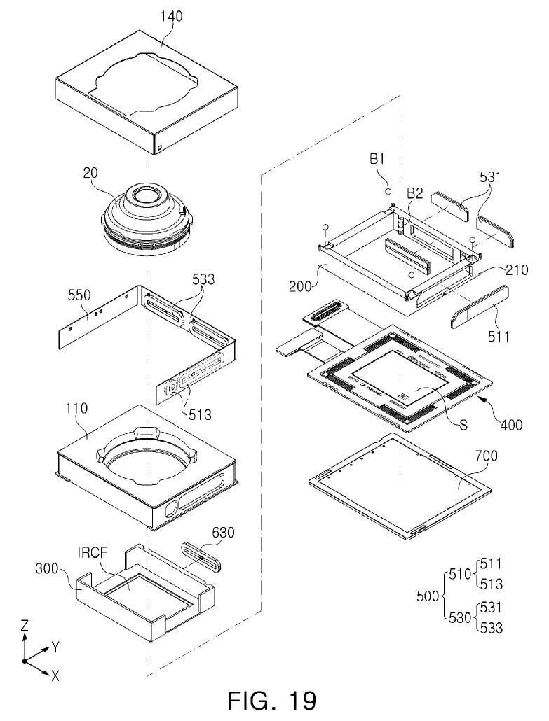

In an embodiment, the first magnet 511 may be configured as a single magnet (see FIG. 19). In this case, the first magnet 511 may be magnetized such that one surface (e.g., the surface facing the first coil 513) may have both a north pole and a south pole. For example, one surface of the first magnet 511 facing the first coil 513 may have a north pole and a south pole spaced apart from each other in the second axis (Y-axis) direction. The other surface (e.g., the opposite surface of the one surface) of the first magnet 511 may be magnetized to have a polarity opposite to that of the one surface of the first magnet 511.

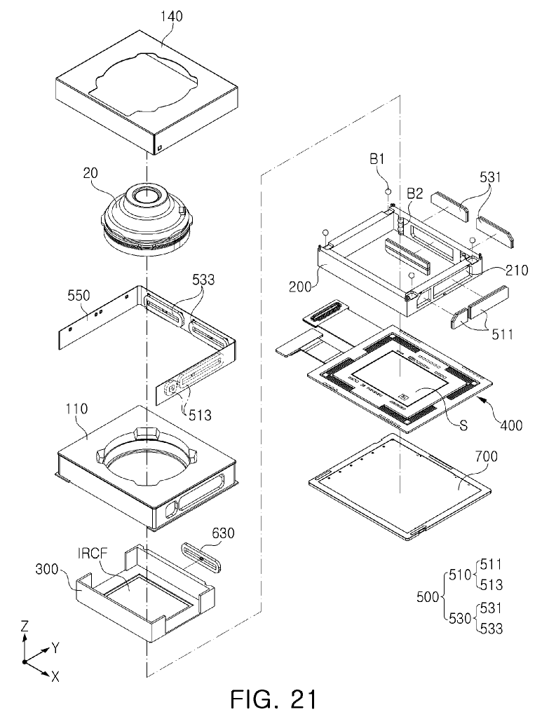

In an embodiment, the first magnet 511 may include a plurality of magnets (see FIG. 21). The plurality of magnets may be spaced apart from each other on one side surface of the first carrier 200 in the second axis (Y-axis) direction. In this case, the plurality of magnets of the first magnet 511 may be configured such that each surface may have one polarity. The plurality of magnets may be configured to have opposite polarities to that of magnets adjacent to each other.

In an embodiment, the first magnet 511 may include a plurality of magnets (see FIG. 3). The plurality of magnets may be spaced apart from each other in the first axis (X-axis) direction. For example, when the first magnet 511 includes two magnets, one of the two magnets may be mounted on one side surface of the first carrier 200, and the other magnet may be mounted on the other side surface (a surface spaced apart from the one side surface in the first axis (X-axis) direction) of the first carrier 200. Each of the plurality of magnets of the first magnet 511 may be magnetized such that one surface (e.g., the surface facing the first coil 513) may have both an N pole and an S pole.

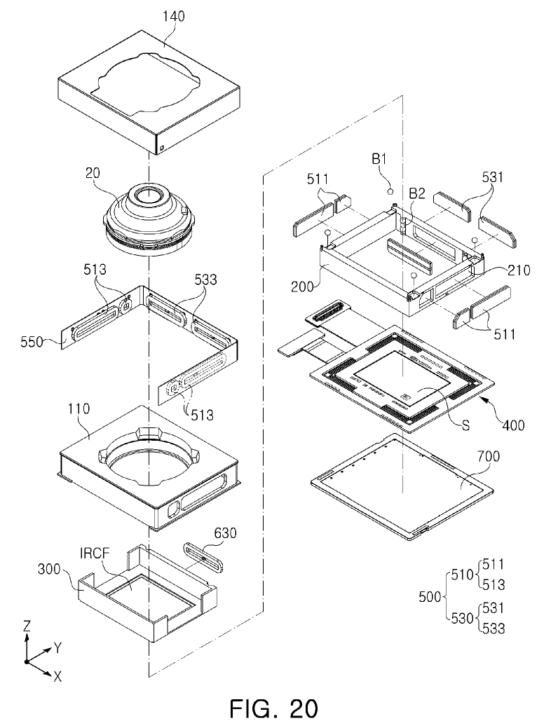

In an embodiment, the first magnet 511 may include a plurality of magnets (see FIG. 20). For example, when the first magnet 511 includes four magnets, two of the four magnets may be mounted on one side surface of the first carrier 200, and the other two magnets may be mounted on the other side surface (a surface spaced apart from the one side surface in the first axis (X-axis) direction) of the first carrier 200. The two magnets mounted on one side surface of the first carrier 200 may be spaced apart from each other in the second axis (Y-axis) direction. The two magnets mounted on the other side surface of the first carrier 200 may also be spaced apart from each other in the second axis (Y-axis) direction. The plurality of magnets of the first magnet 511 may be configured such that each surface thereof (e.g., the surface facing the first coil 513) may have a single polarity.

The first coil 513 may be disposed to face the first magnet 511. For example, the first coil 513 may be disposed to face the first magnet 511 in the direction perpendicular to the optical axis (Z-axis). The first coil 513 may have a toroidal shape having a hollow.

The first coil 513 may be disposed on the first substrate 550. The first substrate 550 may be mounted on the housing 110 such that the first magnet 511 and the first coil 513 may face in the direction perpendicular to the optical axis (Z-axis).

The housing 110 may include a through-hole 111. For example, the through-hole 111 may penetrate a side surface of the housing 110 in the direction perpendicular to the optical axis (Z-axis). The first coil 513 may be disposed in the through-hole 111 of the housing 110. By disposing the first coil 513 in the through-hole 111 of the housing 110, an increase in the sizes of the actuator 10 and the camera module 1 due to the thickness of the first coil 513 may be prevented.

When one surface of the first magnet 511 is magnetized to have both a north pole and a south pole, the first coil 513 may include a greater number of coils than the number of magnets included in the first magnet 511. For example, the number of coils included in the first coil 513 may be twice the number of magnets included in the first magnet 511.

For example, when the first magnet 511 includes only one magnet and one surface of one magnet has both a north pole and a south pole, the first coil 513 may include two coils (see FIG. 19). When the first magnet 511 includes two magnets spaced apart from each other in the first axis (X-axis) direction, and one surface of each magnet has both a north and south pole, the first coil 513 may include four coils (see FIG. 4).

When one surface of the first magnet 511 is magnetized to have a single polarity, the number of coils included in the first coil 513 may be the same as the number of magnets included in the first magnet 511.

For example, when the first magnet 511 includes two magnets spaced apart from each other on one side surface of the first carrier 200 in the second axis (Y-axis) direction, and one surface of the two magnets has a single polarity, the first coil 513 may include two coils (see FIG. 21).

The first magnet 511 may be configured as a moving member mounted on the first carrier 200 and moving together with the first carrier 200, and the first coil 513 may be configured as a fixed member fixed to the first substrate 550 and the housing 110.

When power is applied to the first coil 513, the first carrier 200 may move in the first axis (X-axis) direction by electromagnetic force between the first magnet 511 and the first coil 513.

The second image-stabilization driving unit 530 may include a second magnet 531 and a second coil 533. The second magnet 531 and the second coil 533 may be disposed to face each other in the direction perpendicular to the optical axis (Z-axis).

The second magnet 531 may be disposed on the first carrier 200. For example, the second magnet 531 may be mounted on a side surface of the first carrier 200. A mounting groove 210 in which the second magnet 531 is provided may be provided on a side surface of the first carrier 200. By inserting the second magnet 531 into the mounting groove 210, an increase in the sizes of the actuator 10 and the camera module 1 due to the thickness of the second magnet 531 may be prevented.

The second magnet 531 may include one or a plurality of magnets.

In an embodiment, the second magnet 531 may be configured as a single magnet. In this case, the second magnet 531 may be magnetized such that one surface (e.g., the surface facing the second coil 533) may have both a north pole and a south pole. For example, one surface of the second magnet 531 facing the second coil 533 may have a north pole and a south pole spaced apart from each other in the first axis (X-axis) direction. The other surface of the second magnet 531 (e.g., the opposite surface of the one surface) may be magnetized to have a polarity opposite to that of the one surface of the second magnet 531.

In an embodiment, the second magnet 531 may include a plurality of magnets spaced apart from each other in the first axis (X-axis) direction. In this case, each surface of the plurality of magnets of the second magnet 531 may be configured to have a single polarity. The plurality of magnets may be configured to have opposite polarities to that of magnets adjacent to each other.

The second coil 533 may be disposed to face the second magnet 531. For example, the second coil 533 may be disposed to face the second magnet 531 in the direction perpendicular to the optical axis (Z-axis). The second coil 533 may have a toroidal shape having a hollow.

The second coil 533 may be disposed on the first substrate 550. The first substrate 550 may be mounted on the housing 110 such that the second magnet 531 and the second coil 533 may face each other in the direction perpendicular to the optical axis (Z-axis).

The housing 110 may include a through-hole 111. For example, the through-hole 111 may penetrate a side surface of the housing 110 in the direction perpendicular to the optical axis (Z-axis). The second coil 533 may be disposed in the through-hole 111 of the housing 110. By disposing the second coil 533 in the through-hole 111 of the housing 110, an increase in the overall size of the actuator 10 and the camera module 1 due to the thickness of the second coil 533 may be prevented.

The second coil 533 may include a plurality of coils. The plurality of coils of the second coil 533 may be spaced apart from each other in the first axis (X-axis) direction.

The second magnet 531 may be a moving member mounted on the first carrier 200 and moving together with the first carrier 200, and the second coil 533 may be a fixed member fixed to the first substrate 550 and housing 110.

When power is applied to the second coil 533, the first carrier 200 may move in the second axis (Y-axis) direction due to electromagnetic force between the second magnet 531 and the second coil 533.

As illustrated in FIG. 4, the first coil 513 and the second coil 533 may be provided as wound coils and may be mounted on the first substrate 550. In another embodiment, the first coil 513 and the second coil 533 may be copper patterns stacked on and buried in the first substrate 550.

The first magnet 511 and the second magnet 531 may be disposed perpendicular to each other on a plane perpendicular to the optical axis (Z-axis), and the first coil 513 and the second coil 533 may also be disposed perpendicular to each other on a plane perpendicular to the optical axis (Z-axis).

The first ball member B1 may be disposed between the housing 110 and the first carrier 200.

The first ball member B1 may be disposed to be in contact with each of the housing 110 and the first carrier 200.

The first ball member B1 may guide the movement of the first carrier 200 during an image stabilization process, and may also maintain a distance between the housing 110 and the first carrier 200 in the optical axis (Z-axis) direction.

When the first carrier 200 moves relative to the housing 110 in the direction perpendicular to the optical axis (Z-axis), the first ball member B1 may guide the movement of the first carrier 200 by rolling in the direction perpendicular to the optical axis (Z-axis).

For example, the first ball member B1 may roll in the first axis (X-axis) direction when driving force is generated in the first axis (X-axis) direction. Accordingly, the first ball member B1 may guide the movement of the first carrier 200 in the first axis (X-axis) direction.

Furthermore, the first ball member B1 may roll in the second axis (Y-axis) direction when a driving force is generated in the second axis (Y-axis) direction. Accordingly, the first ball member B1 may guide the movement of the first carrier 200 in the second axis (Y-axis) direction.

The first ball member B1 may include a plurality of balls disposed between the housing 110 and the first carrier 200. The number of balls included in the first ball member B1 may be three or more.

A guide groove in which the first ball member B1 is disposed may be disposed on at least one of surfaces of the housing 110 and the first carrier 200 facing each other in the optical axis (Z-axis) direction. For example, the first guide groove 230 may be disposed on the upper surface of the first carrier 200, and the second guide groove 120 may be disposed on the inner upper surface of the housing 110.

The first ball member B1 may be disposed in the first guide groove 230 and the second guide groove 120, and may be interposed between the housing 110 and the first carrier 200.

The first ball member B1 may move in the direction perpendicular to the optical axis (Z-axis) while being accommodated in the first guide groove 230 and the second guide groove 120, and the movement thereof in the optical axis (Z-axis) direction may be limited.

Each of planes of the first guide groove 230 and the second guide groove 120 may have a polygonal or circular shape. Sizes of the first guide groove 230 and the second guide groove 120 may be greater than a diameter of the first ball member B1. For example, cross-sections of the first guide groove 230 and the second guide groove 120 on a plane perpendicular to the optical axis (Z-axis) may have a size greater than the diameter of the first ball member B1.

The first carrier 200 may include a support pad 231, and at least a portion of the support pad 231 may form a bottom surface of the first guide groove 230. Accordingly, the first ball member B1 may roll by being in contact with the support pad 231.

In an embodiment, the support pad 231 may be integrated and coupled to the first carrier 200 by insert molding. In this case, the support pad 231 may be manufactured to be integrated with the first carrier 200 by injecting resin into the mold while the support pad 231 is fixed in the mold. The support pad 231 may be formed of stainless steel.

The support pad 231 may also be provided in the housing 110.

According to an embodiment, an actuator 10 may sense a position of the first carrier 200 in the direction perpendicular to the optical axis (Z-axis).

To this end, a first position sensor 515 and a second position sensor 535 may be provided. The first position sensor 515 may be disposed on the first substrate 550 to face the first magnet 511, and the second position sensor 535 may be disposed on the first substrate 550 to face the second magnet 531.

The second position sensor 535 may include a plurality of position sensors. Each of the plurality of position sensors may be a Hall sensor.

For example, the second position sensor 535 may include two Hall sensors. The two Hall sensors of the second position sensor 535 may be spaced apart from each other in the first axis (X-axis) direction. The direction in which the two Hall sensors of the second position sensor 535 are spaced apart from each other and the direction in which the second magnet 531 and the second coil 533 face each other may be perpendicular to each other.

For example, the second magnet 531 may include two magnets spaced apart from each other in the direction (the first axis (X-axis) direction) perpendicular to the direction in which driving force is generated by the second magnet 531 (the second axis (Y-axis) direction), and the second position sensor 535 may include two Hall sensors facing the two magnets.

One of the two Hall sensors may face one of the two magnets of the second magnet 531, and the other of the two Hall sensors may face the other of the two magnets of the second magnet 531.

Whether the first carrier 200 rotates may be sensed through the two Hall sensors facing the second magnet 531.

Rotational force may be intentionally generated by creating a difference between driving force of the first image-stabilization driving unit 510 and driving force of the second image-stabilization driving unit 530, using resultant forces of the first image-stabilization driving unit 510 and the second image-stabilization driving unit 530, or using two magnets included in the second image-stabilization driving unit 530.

Accordingly, when an unintended rotation occurs in the first carrier 200, driving force of the first image-stabilization driving unit 510 and/or driving force of the second image-stabilization driving unit 530 may be controlled to offset the rotation, thereby allowing the first carrier 200 to move linearly.

A first yoke 570 may be disposed in the housing 110. The first yoke 570 may provide attractive force to maintain contact between the housing 110 and the first carrier 200 with the first ball member B1.

The first yoke 570 may be buried in the housing 110. For example, the first yoke 570 may be integrated and coupled to the housing 110 by insert injection. In this case, the first yoke 570 may be manufactured to be integrated and coupled to the housing 110 by injecting resin into the mold while the first yoke 570 is fixed in a mold.

The first yoke 570 may be disposed to face the first magnet 511 and the second magnet 531 in the optical axis (Z-axis) direction.

Attractive force may be applied between the first yoke 570 and the first magnet 511, and between the first yoke 570 and the second magnet 531 in the optical axis (Z-axis) direction.

Accordingly, as the first carrier 200 is pressed toward the housing 110, the housing 110 and the first carrier 200 may maintain contact with the first ball member B1.

Due to this attractive force, the first carrier 200 may form at least three-point support for the first ball member B1.

The first yoke 570 may be a material generating attractive force between the first magnet 511 and the second magnet 531. For example, the first yoke 570 may be a magnetic material.

The number of first yokes 570 is not limited to any particular example, but a center of action of the attractive force acting between the first yoke 570 and the first magnet 511, and the attractive force acting between the first yoke 570 and the second magnet 531 may need to be positioned in a support region connecting the plurality of balls included in the first ball member B1 to each other.

Referring to FIGS. 4, 5 and 6, the actuator 10 may include a damping unit. The damping unit may include a plurality of damping grooves 130, a plurality of damping pins 250, and damping gel.

The housing 110 may include the plurality of damping grooves 130 disposed therein. For example, the plurality of damping grooves 130 may be formed on an inner upper surface of the housing 110. The plurality of damping grooves 130 may be disposed neighboring to the second guide groove 120.

The first carrier 200 may include the plurality of damping pins 250 extending toward the plurality of damping grooves 130. For example, the plurality of damping pins 250 protruding in the optical axis (Z-axis) direction may be disposed at an edge of an upper surface of the first carrier 200.

At least a portion of the damping pins 250 extending from the first carrier 200 may be accommodated in each damping groove 130. For example, the plurality of damping pins 250 protruding from the first carrier 200 may be disposed on the first carrier 200 to extend in the optical axis (Z-axis) direction, and at least a portion of each damping pin 250 may be disposed in each damping groove 130 of the housing 110.

Damping gel may be disposed in the plurality of damping grooves 130. A portion of the damping pin 250 may be disposed in the damping gel.

During image stabilization, as the first carrier 200 is a moving member and the housing 110 is a fixed member, the damping pin 250 may move relative to the damping groove 130. Furthermore, since the damping pin 250 is immersed in the damping gel, resistance may be generated by the damping gel when the damping pin 250 moves. Accordingly, a damping structure may be easily implemented.

Referring to FIGS. 8 and 9, the first magnet 511 may be magnetized such that one surface (e.g., the surface facing the first coil 513) thereof has both a north pole and a south pole.

For example, one surface of the first magnet 511 may have a first polarity 511a and a second polarity 511b spaced apart from each other in the second axis (Y-axis) direction. The first polarity 511a may be a north pole or a south pole, and the second polarity 511b may have a polarity opposite to the first polarity 511a.

An area of the first polarity 511a may be different from an area of the second polarity 511b. For example, the area of the first polarity 511a may be greater than the area of the second polarity 511b.

A length in the second axis (Y-axis) direction of the first polarity 511a and a length in the second axis (Y-axis) direction of the second polarity 511b may be different. For example, a length in the second axis (Y-axis) direction of the first polarity 511a may be longer than a length in the second axis (Y-axis) direction of the second polarity 511b.

The first coil 513 may include a plurality of coils. For example, the first coil 513 may include a first sub-coil 513a and a second sub-coil 513b.

The first sub-coil 513a may be disposed to face the first polarity 511a of the first magnet 511, and the second sub-coil 513b may be disposed to face the second polarity 511b of the first magnet 511.

A length in the second axis (Y-axis) direction of the first sub-coil 513a may be different from a length in the second axis (Y-axis) direction of the second sub-coil 513b. For example, a length in the second axis (Y-axis) direction of the first sub-coil 513a may be formed longer than a length in the second axis (Y-axis) direction of the second sub-coil 513b.

The first position sensor 515 may be disposed in a position spaced apart from a center of the first sub-coil 513a. For example, the first position sensor 515 may be disposed in a position spaced apart from a center of the first sub-coil 513a in the second axis (Y-axis) direction.

A position in the second axis (Y-axis) direction of the first position sensor 515 may be between the center of the first sub-coil 513a and the center of the second sub-coil 513b. That is, the first position sensor 515 may be disposed between the center of the first sub-coil 513a and the center of the second sub-coil 513b.

The first position sensor 515 may be disposed to face one of the first polarity 511a and the second polarity 511b of the first magnet 511. For example, the first position sensor 511 may be disposed to face a polarity having a longer length (or greater area) among the first polarity 511a and the second polarity 511b of the first magnet 511.

In an embodiment, the first position sensor 515 may be disposed to face the first polarity 511a of the first magnet 511.

The first position sensor 515 may be spaced apart from a center C1 of the first polarity 511a of the first magnet 511. Accordingly, the first position sensor 515 may face a portion of the first magnet 511 spaced apart from the center C1 of the first polarity 511a in the second axis (Y-axis) direction.

In an embodiment, the center of the first position sensor 515 may be spaced apart from the center C1 of the first polarity 511a of the first magnet 511 in the second axis (Y-axis) direction. Here, the direction in which the first position sensor 515 is spaced apart from the center C1 may be a direction toward the second polarity 511b of the first magnet 511.

For example, the first position sensor 515 may face the first polarity 511a of the first magnet 511, and a center of the first position sensor 515 may be positioned between a center C1 of the first polarity 511a of the first magnet 511 and a center C2 of the second polarity 511b of the first magnet 511.

In an embodiment, the first position sensor 515 may be positioned to face the center C3 of the first carrier 200. For example, when viewed in the first axis (X-axis) direction, the center C3 in the second axis (Y-axis) direction of one side surface of the first carrier 200, on which the first magnet 511 is disposed, may overlap the first position sensor 515.

The first position sensor 515 may sense a position of the first carrier 200 when the first carrier 200 moves in the first axis (X-axis) direction. The first position sensor 515 may be a Hall sensor.

During image stabilization, the first carrier 200 may move in the first axis (X-axis) and second axis (Y-axis) directions while being supported by the first ball member B1.

In this case, as the first ball member B1 may roll in multiple directions perpendicular to the optical axis (Z-axis), there may be a possibility that the first carrier 200 may rotate due to various unintended factors, such as a difference between driving force of the first image-stabilization driving unit 510 and driving force of the second image-stabilization driving unit 530.

In this case, an error may occur in a position of the first carrier 200 sensed by the first position sensor 515.

In the camera module 1 according to an embodiment, a length of the first sub-coil 513a may be formed longer than a length of the second sub-coil 513b, and the first position sensor 515 may be disposed in a position spaced apart from the center of the first sub-coil 513a.

Also, the first position sensor 515 may be disposed to face a polarity (e.g., the first polarity 511a) having a longer length on one surface of the first magnet 511, and the first position sensor 515 may be disposed to be closer to the second polarity 511b from the center of the first polarity 511a.

Accordingly, the first position sensor 515 may be positioned closer to the center of the first carrier 200 (preferably, positioned such that the first position sensor 515 faces the center of the first carrier 200), such that, even when the first carrier 200 rotates unintentionally, an error in the position (position in the first axis (X-axis) direction) of the first carrier 200 sensed by the first position sensor 515 may be prevented.

As illustrated in FIGS. 10A, 10B, and 10C, even when the first carrier 200 rotates, a distance between the first magnet 511 and the first position sensor 515 may not change, or the change thereof may be relatively insignificant.

Accordingly, the position of the first carrier 200 sensed by the first position sensor 515 may not be affected by rotation of the first carrier 200.

The second coil 533 may include a plurality of coils. For example, the second coil 533 may include a third sub-coil 533a and a fourth sub-coil 533b. The third sub-coil 533a and the fourth sub-coil 533b may be spaced apart from each other in the first axis (X-axis) direction.

When the second magnet 531 is a single magnet, the third sub-coil 533a and the fourth sub-coil 533b may be disposed to face different polarities of one surface of the second magnet 531.

When the second magnet 531 is a plurality of divided magnets (for example, two), each of the third sub-coil 533a and the fourth sub-coil 533b may face a single magnet.

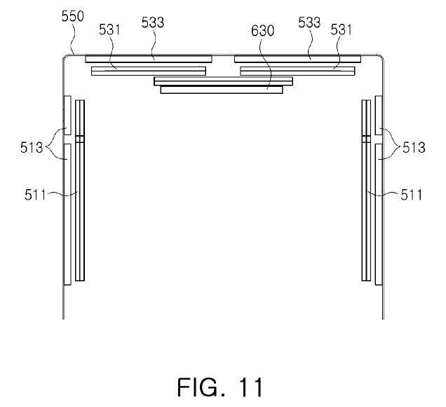

FIGS. 11, 12, and 13 are diagrams illustrating modified examples of a first magnet and a first coil of first driver.

In an embodiment, the first magnet 511 may include two magnets spaced apart from each other in the first axis (X-axis) direction. Each magnet may be configured such that one surface facing the first coil 513 may have a first polarity and a second polarity.

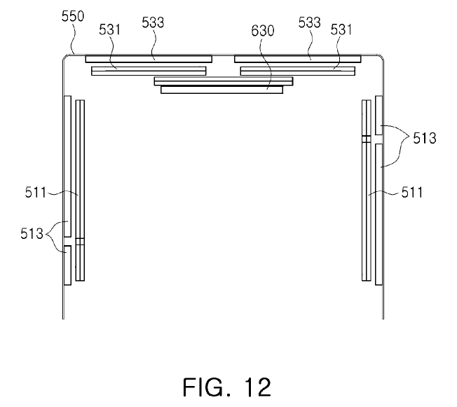

First, as illustrated in FIGS. 3 and 12, the first polarity of a magnet positioned in the positive first axis (X-axis) direction and the first polarity of a magnet positioned in the negative first axis (X-axis) direction may be disposed to face each other in an orthogonal direction.

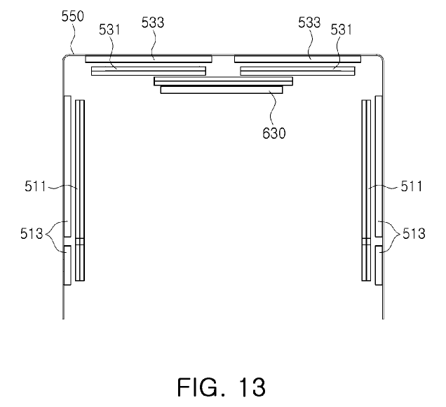

Referring to FIGS. 11 and 13, the first polarity of a magnet positioned in the positive first axis (X-axis) direction and the first polarity of a magnet positioned in the negative first axis (X-axis) direction may be disposed to face each other in the first axis (X-axis) direction.

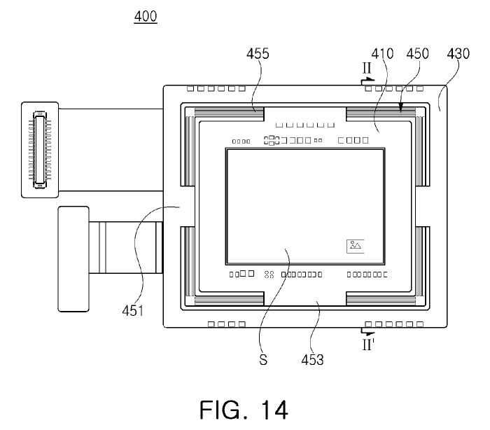

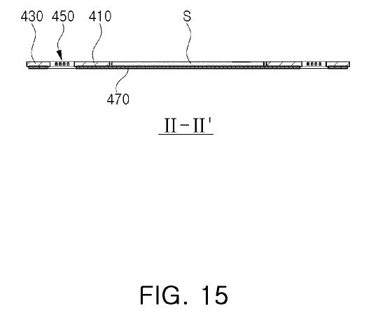

FIG. 14 is a plan diagram illustrating a sensor substrate 400 of an actuator 10 according to an embodiment. FIG. 15 is a cross-sectional diagram taken along line II-II’ in FIG. 14.

Referring to FIGS. 14 and 15, the sensor substrate 400 may include a moving portion 410, a fixed portion 430, and a connecting portion 450. The sensor substrate 400 may be a rigid flexible PCB (RF PCB).

An image sensor S may be mounted on the moving portion 410. The moving portion 410 may be coupled to a lower surface of a second carrier 300, which will be described later. For example, an area of the moving portion 410 may be greater than an area of the image sensor S, and the moving portion 410 in an outer portion of the image sensor S may be coupled to a lower surface of the second carrier 300.

The moving portion 410 may be a moving member moving together with the first carrier 200 and the second carrier 300 during image stabilization. The moving portion 410 may be a rigid printed circuit board (PCB).

The fixed portion 430 may be coupled to a lower surface of the housing 110. The fixed portion 430 may be a fixed member not moving during image stabilization. The fixed portion 430 may be a rigid PCB.

The connecting portion 450 may be disposed between the moving portion 410 and the fixed portion 430 and may connect the moving portion 410 to the fixed portion 430. The connecting portion 450 may be a flexible PCB. When the moving portion 410 moves, the connecting portion 450 disposed between the moving portion 410 and the fixed portion 430 may be bent.

The connecting portion 450 may extend along a circumference of the moving portion 410. The connecting portion 450 may include a plurality of slits penetrating the connecting portion 450 in the optical axis (Z-axis) direction. The plurality of slits may be disposed with a distance between the moving portion 410 and the fixed portion 430. Accordingly, the connecting portion 450 may include a plurality of bridge elements 455 spaced apart from each other by the plurality of slits. The plurality of bridge elements 455 may extend along a circumference of the moving portion 410.

The connecting portion 450 may include a first support portion 451 and a second support portion 453. The connecting portion 450 may be connected to the fixed portion 430 through the first support portion 451. The connecting portion 450 may be connected to the moving portion 410 through the second support portion 453.

For example, the first support portion 451 may be in contact with and connected to the fixed portion 430, and may be spaced apart from the moving portion 410. The second support portion 453 may be in contact with and connected to the moving portion 410, and may be spaced apart from the fixed portion 430.

For example, the first support portion 451 may extend in the first axis (X-axis) direction and may connect a plurality of bridge elements 455 of the connecting portion 450 to the fixed portion 430. In an embodiment, the first support portion 451 may include two support portions disposed opposite each other in the first axis (X-axis) direction.

The second support portion 453 may extend in the second axis (Y-axis) direction and may connect the plurality of bridge elements 455 of the connecting portion 450 to the moving portion 410. In an embodiment, the second support portion 453 may include two support portions disposed opposite each other in the second axis (Y-axis) direction.

Accordingly, the moving portion 410 may move in the direction perpendicular to the optical axis (Z-axis) or may rotate about the optical axis (Z-axis) while being supported by the connecting portion 450.

In an embodiment, when the image sensor S moves in the first axis (X-axis) direction, the plurality of bridge elements 455 connected to the first support portion 451 may be bent. When the image sensor S moves in the second axis (Y-axis) direction, the plurality of bridge elements 455 connected to the second support portion 453 may be bent. When the image sensor S rotates, the plurality of bridge elements 455 connected to the first support portion 451 and the plurality of bridge elements 455 connected to the second support portion 453 may be bent together.

In an embodiment, a length in the first axis (X-axis) direction of the fixed portion 430 and a length in the second axis (Y-axis) direction may be different. For example, the length in the second axis (Y-axis) direction of the fixed portion 430 may be longer than the length in the first axis (X-axis) direction. In an embodiment, the sensor substrate 400 may have a rectangular shape.

In the sensor substrate 400 configured as above, when the length of the first support portion 451 and the length of the second support portion 453 are the same, the load applied to the plurality of bridge elements 455 connected to the first support portion 451 and the load applied to the plurality of bridge elements 455 connected to the second support portion 453 may be different, such that there may be a difficulty in driving control.

Accordingly, by configuring a length of the first support portion 451 and a length of the second support portion 453 to be different, the length of the plurality of bridge elements 455 extending from the first support portion 451 in the second axis (Y-axis) direction and the length of the plurality of bridge elements 455 extending from the second support portion 453 in the first axis (X-axis) direction may be configured to be almost the same.

Here, the length of the first support portion 451 may indicate the length in the second axis (Y-axis) direction, and the length of the second support portion 453 may indicate the length in the first axis (X-axis) direction.

Referring to FIG. 15, a through-hole may be formed in the moving portion 410, and the image sensor S may be disposed in the through-hole. A thickness of the through-hole and a thickness of the image sensor S may be almost the same.

A reinforcing plate 470 may be coupled to a lower surface of the moving portion 410. The reinforcing plate 470 may also be coupled to a lower surface of the fixed portion 430.

Accordingly, as compared to disposing the image sensor S on the upper surface of the sensor substrate 400, the height in the optical axis (Z-axis) direction may be reduced by the thickness of the image sensor S.

Referring to FIG. 2, a base 700 may be coupled to a lower portion of the sensor substrate 400.

The base 700 may be coupled to the sensor substrate 400 to cover the lower portion of the sensor substrate 400. The base 700 may prevent foreign substances from entering through a distance between the moving portion 410 and the fixed portion 430 of the sensor substrate 400.

A heat-dissipating film may be disposed on the lower portion of the base 700. Accordingly, heat generated from the image sensor S may be effectively dissipated.

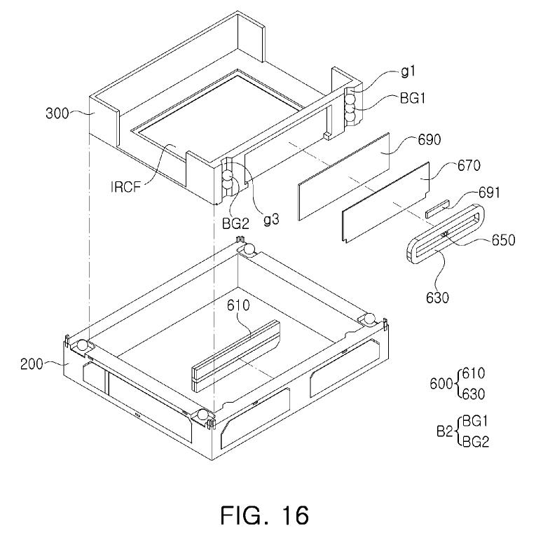

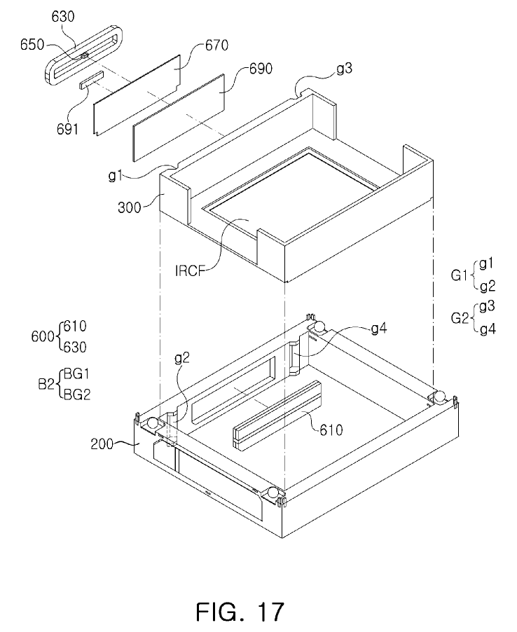

FIG. 16 is an exploded perspective diagram illustrating a first carrier, a second carrier and a second driver according to an embodiment. FIG. 17 is a perspective diagram illustrating the example illustrated in FIG. 16 in a different direction.

Referring to FIGS. 16, 17, and 18, the second carrier 300 may be disposed in the first carrier 200.

The second carrier 300 may be disposed in the first carrier 200 and may move along the direction perpendicular to the optical axis (Z-axis) together with the first carrier 200, and may move relative to the first carrier 200 in the optical axis (Z-axis) direction.

The second driving unit 600 may move the second carrier 300 in the optical axis (Z-axis) direction by generating driving force in the optical axis (Z-axis) direction.

The second driving unit 600 may include a third magnet 610 and a third coil 630. The third magnet 610 and the third coil 630 may be disposed to face each other in the direction perpendicular to the optical axis (Z-axis).

The third magnet 610 may be disposed in one of the first carrier 200 or the second carrier 300, and the third coil 630 may be disposed in the other. In the description below, the embodiment in which the third magnet 610 is disposed in the first carrier 200 will be described, but the positions of the third magnet 610 and the third coil 630 may be interchanged.

The third magnet 610 may be disposed in the first carrier 200. For example, the third magnet 610 may be disposed on an inner side surface of the first carrier 200. The third magnet 610 may be disposed to overlap the second magnet 531 in the second axis (Y-axis) direction.

The third magnet 610 may be magnetized such that one surface (e.g., the surface facing the third coil 630) may have both a north pole and a south pole. For example, a north pole, a neutral region, and a south pole may be provided in order on one surface of the third magnet 610 facing the third coil 630 in the optical axis (Z-axis) direction.

The other surface of the third magnet 610 (e.g., the opposite surface of the one surface) may be magnetized to have both a south pole and a north pole. For example, a south pole, a neutral region, and a north pole may be disposed in order on the other surface of the third magnet 610 in the optical axis (Z-axis) direction.

The third coil 630 may be disposed in the second carrier 300. For example, the third coil 630 may be disposed on one side surface of the second carrier 300. The third coil 630 may be disposed to face the third magnet 610 in the direction perpendicular to the optical axis (Z-axis).

The third coil 630 may be disposed on the second substrate 670, and the second substrate 670 may be mounted on the second carrier 300 such that the third magnet 610 and the third coil 630 may face each other in the direction perpendicular to the optical axis (Z-axis).

During focusing, the third magnet 610 may be a fixed member fixed to the first carrier 200, and the third coil 630 may be a moving member mounted on the second substrate 670 and the second carrier 300, and moving in the optical axis (Z-axis) direction together with the second carrier 300.

When power is applied to the third coil 630, the second carrier 300 may move in the optical axis (Z-axis) direction by electromagnetic force between the third magnet 610 and the third coil 630.

As the sensor substrate 400 on which the image sensor S is mounted is coupled to the second carrier 300, the image sensor S may also move in the optical axis (Z-axis) direction as the second carrier 300 moves.

A second ball member B2 may be disposed between the first carrier 200 and the second carrier 300. The second ball member B2 may include a plurality of balls disposed in the optical axis (Z-axis) direction. The plurality of balls may roll in the optical axis (Z-axis) direction as the second carrier 300 moves in the optical axis (Z-axis) direction.

A second yoke 690 may be disposed in the second carrier 300. The second yoke 690 may be disposed in a position facing the third magnet 610. For example, a third coil 630 may be disposed on one surface of the second substrate 670, and a second yoke 690 may be disposed on the other surface of the second substrate 670.

The third magnet 610 and the second yoke 690 may generate attractive force therebetween. For example, attractive force may act between the third magnet 610 and the second yoke 690 in the direction perpendicular to the optical axis (Z-axis).

Due to the attractive force of the third magnet 610 and the second yoke 690, the second ball member B2 may be in contact with each of the first carrier 200 and the second carrier 300.

A guide groove may be disposed in the surface in which the first carrier 200 and the second carrier 300 face each other. For example, a first groove g1 and a third groove g3 may be disposed in the second carrier 300, and a second groove g2 and a fourth groove g4 may be disposed in the first carrier 200. Each groove may have a shape having a length in the optical axis (Z-axis) direction.

The first groove g1 and the second groove g2 may be disposed to face in the direction perpendicular to the optical axis (Z-axis), and a portion of the plurality of balls of the second ball member B2 (e.g., the first ball group BG1 described below) may be disposed in the space between the first groove g1 and the second groove g2.

Among the plurality of balls included in the first ball group BG1, balls positioned on the outermost side in a direction parallel to the optical axis (Z-axis) may be in two-point contact with the first groove g1 and the second groove g2, respectively.

That is, among the plurality of balls included in the first ball group BG1, balls positioned on the outermost side in the direction parallel to the optical axis (Z-axis) may be in two-point contact with the first groove g1 and may be in two-point contact with the second groove g2.

The first groove g1 and the second groove g2 may form a main rolling portion G1, and the first ball group BG1 and the main rolling portion G1 may function as a main guide which guides the movement of the second carrier 300 in the optical axis (Z-axis) direction.

The third groove g3 and the fourth groove g4 may be disposed to face each other in the direction perpendicular to the optical axis (Z-axis) direction, and a portion of a plurality of balls of the second ball member B2 (e.g., the second ball group BG2 described below) may be disposed in the space between the third groove g3 and the fourth groove g4.

Among the plurality of balls included in the second ball group BG2, balls positioned on an outermost side in a direction parallel to the optical axis (Z-axis) may be in two-point contact with one of the third groove g3 and the fourth groove g4 and may be in one-point contact with the other.

For example, among the plurality of balls included in the second ball group BG2, balls positioned on the outermost side in a direction parallel to the optical axis (Z-axis) may be in one-point contact with the third groove g3 and may be in two-point contact with the fourth groove g4 (or vice versa).

The third groove g3 and the fourth groove g4 may form an auxiliary rolling portion G2, and the second ball group BG2 and the auxiliary rolling portion G2 may function as an auxiliary guide supporting the movement of the second carrier 300 in the optical axis (Z-axis) direction.

The second ball member B2 may include the first ball group BG1 and the second ball group BG2, and each of the first ball group BG1 and the second ball group BG2 may include a plurality of balls disposed in the optical axis (Z-axis) direction.

The first ball group BG1 and the second ball group BG2 may be spaced apart from each other in the direction perpendicular to the optical axis (Z-axis) (e.g., the X-axis direction). The number of balls in the first ball group BG1 and the number of balls in the second ball group BG2 may be different.

For example, the first ball group BG1 may include two or more balls disposed in the optical axis (Z-axis) direction, and the second ball group BG2 may include a smaller number of balls than the number of balls included in the first ball group BG1.

The number of balls in each ball member may be varied under the assumption that the number of balls in the first ball group BG1 and the number of balls in the second ball group BG2 may be different. For ease of description, in the description below, the embodiment in which the first ball group BG1 includes three balls and the second ball group BG2 includes two balls will be described.

Among the three balls included in the first ball group BG1, two balls disposed on the outermost side in the direction parallel to the optical axis (Z-axis) may have the same diameter, and one ball disposed therebetween may have a diameter less than the balls disposed on the outermost side.

For example, among the plurality of balls included in the first ball group BG1, two balls disposed on the outermost side in the direction parallel to the (Z-axis) may have a first diameter, and one ball disposed therebetween may have a second diameter, and the first diameter may be greater than the second diameter.

The two balls included in the second ball group BG2 may have the same diameter. For example, the two balls included in the second ball group BG2 may have a third diameter.

The first and third diameters may be the same. Here, the same diameter may indicate that the diameters are physically the same, and that manufacturing errors are included.

A distance between centers of the balls disposed on the outermost side in a direction parallel to the optical axis (Z-axis) among the plurality of balls included in the first ball group BG1 and a distance between centers of the balls disposed on the outermost side in a direction parallel to the optical axis (Z-axis) among the plurality of balls included in the second ball group BG2 may be different.

For example, the distance between the centers of two balls having the first diameter may be greater than the distance between the centers of two balls having the third diameter.

In order for the second carrier 300 to move parallel to the optical axis (Z-axis) when moving in the optical axis (Z-axis) direction (that is, to prevent tilt), the center of action CP of attractive force acting between the third magnet 610 and the second yoke 690 may need to be positioned in a support region A connecting contact points of the second ball member B2 and the second carrier 300 (or the first carrier 200) to each other.

When the center of action CP of the attractive force is beyond the support region A, a position of the second carrier 300 may be distorted while the second carrier 300 moves, tilting may occur. Accordingly, it may be necessary to configure the support region A to have a relatively wide area.

In an embodiment, the size (for example, a diameter) of a portion of the plurality of balls of the second ball member B2 may be smaller than the size (for example, a diameter) of the other balls. In this case, among the plurality of balls, balls having a greater diameter may be intentionally in contact with the second carrier 300 (or the first carrier 200).

Since the diameters of two of the three balls in the first ball group BG1 are greater than the diameter of the other ball, the two balls in the first ball group BG1 may be in contact with the first carrier 200 and the second carrier 300, respectively. As the two balls in the second ball group BG2 have the same diameter, the two balls in the second ball group BG2 may be in contact with the first carrier 200 and the second carrier 300, respectively.

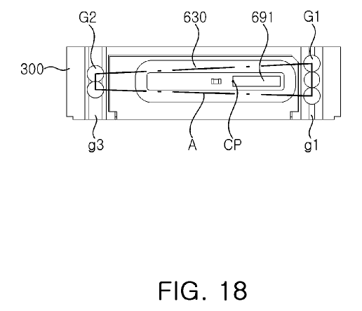

Accordingly, as illustrated in FIG. 18, when viewed in the second axis (Y-axis) direction, the second ball member B2 may be in four-point contact with the first carrier 200 (or second carrier 300). The support region A connecting the contact points to each other may have a rectangular shape (e.g., a trapezoidal shape).

Accordingly, the support region A may be formed to have a relatively wide area, and accordingly, the center of action CP of attractive force acting between the third magnet 610 and the second yoke 690 may be stably positioned in the support region A. Accordingly, operating stability during focusing may be ensured.

Even when the two balls of the second ball group BG2 are manufactured to have the same diameter, the two balls of the second ball group BG2 may not physically have the exact same diameter due to manufacturing errors. In this case, one of the two balls of the second ball group BG2 may be in contact with the second carrier 300 (or the first carrier 200).

Accordingly, the support region A connecting the contact points at which the second ball member B2 is in contact with the second carrier 300 (or the first carrier 200) may have a triangular shape.

Even when the support region A has a triangular shape, the support region A may be formed to have a wide area by the balls positioned on the outermost side in the direction parallel to the optical axis (Z-axis) among the three balls in the first ball group BG1, operational stability during focusing may be ensured.

Aside from ensuring operational stability during focusing, reducing the height of camera module 1 in the optical axis (Z-axis) direction (that is, slimming) may also be important. Simply reducing the height of the camera module 1 in the optical axis (Z-axis) direction may also reduce the height of support region A in the optical axis (Z-axis) direction.

In other words, simply reducing the height of camera module 1 in the optical axis (Z-axis) direction may lead to operational stability issues during focusing.

In an embodiment, an auxiliary yoke 691 may be disposed in a position facing the third magnet 610. For example, the auxiliary yoke 691 may be disposed on the inner side of the third coil 630 to face the third magnet 610.

The auxiliary yoke 691 may be positioned closer to the main guide G1 than the auxiliary guide G2. The auxiliary yoke 691 may be formed of a material generating attractive force toward the third magnet 610.

Accordingly, resultant force of the attractive force acting between the third magnet 610 and the second yoke 690 and the attractive force generated between the third magnet 610 and the auxiliary yoke 691 may be positioned closer to the main guide G1 than the auxiliary guide G2.

In another embodiment, the third magnet 610 may be disposed eccentrically to one side of the third magnet 610 in the longitudinal direction (e.g., the second axis (Y-axis) direction) on one inner side surface of the first carrier 200.

A center of one inner side surface of the first carrier 200 and a center of the third magnet 610 may be shifted from each other. The direction in which the third magnet 610 is eccentric may be toward a main guide G1.

That is, the third magnet 610 may be disposed closer to the main guide G1 than the auxiliary guide G2.

Since the support region A has a longer length in optical axis (Z-axis) direction toward the main guide, by disposing the third magnet 610 closer to the main guide, the center of action CP of the attractive force may be stably positioned in the support region A.

The actuator 10 may sense the position of the second carrier 300 in the optical axis (Z-axis) direction.

To this end, a third position sensor 650 may be provided. The third position sensor 650 may be disposed on the second substrate 670 to face the third magnet 610. The third position sensor 650 may be a Hall sensor.

In the camera module 1 according to an embodiment, the image sensor S may be configured to move in the optical axis (Z-axis) direction during autofocusing, and to move in the direction perpendicular to the optical axis (Z-axis) during image stabilization.

Even when the image sensor S moves in the optical axis (Z-axis) direction during focusing, the relative positions of the magnets and coils of the first driving unit 500 may not change, such that driving force for image stabilization may be precisely controlled.

Also, even when the image sensor S moves in the direction perpendicular to the optical axis (Z-axis) during image stabilization, the relative positions of the magnets and coils of the second driving unit 600 may not change, driving force for focusing may be precisely controlled.

According to the aforementioned embodiments, the actuator for camera may improve image stabilization performance.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An actuator for camera, comprising:
a housing comprising an internal space;
a first carrier accommodated in the housing; and
a first driving unit comprising a first magnet disposed in the first carrier, a first coil disposed to face the first magnet in a first-axis direction, and a first position sensor configured to sense a position of the first carrier,
wherein the first coil comprises a first sub-coil and a second sub-coil spaced apart from each other in a second-axis direction perpendicular to the first-axis direction,
wherein a length in the second-axis direction of the first sub-coil is longer than a length in the second-axis direction of the second sub-coil, and
wherein the first position sensor is disposed in a position spaced apart from a center of the first sub-coil in the second-axis direction.

2. The actuator of claim 1, wherein a position in the second-axis direction of the first position sensor is between a center of the first sub-coil and a center of the second sub-coil.

3. The actuator of claim 1,
wherein a surface of the first magnet facing the first coil has a first polarity and a second polarity spaced apart from each other in the second-axis direction,
wherein the first polarity and the second polarity are opposite polarities, and
wherein the first polarity faces the first sub-coil, and the second polarity faces the second sub-coil.

4. The actuator of claim 3,
wherein a length in the second-axis direction of the first polarity is longer than a length in the second-axis direction of the second polarity, and
wherein the first position sensor faces a portion of the first magnet spaced apart from a center of the first polarity in the second-axis direction.

5. The actuator of claim 3, wherein a position in the second-axis direction of the first position sensor is between a center of the first polarity and a center of the second polarity.

6. The actuator of claim 1, wherein, when viewed in the first-axis direction, a center in the second-axis direction of a side surface of the first carrier, on which the first magnet is disposed, overlaps the first position sensor.

7. The actuator of claim 1, further comprising:
a first ball member disposed between the housing and the first carrier,
wherein a guide groove in which the first ball member is disposed is disposed on at least one of a surface of the housing and a surface the first carrier, facing each other in a direction perpendicular to both the first-axis direction and the second-axis direction.

8. The actuator of claim 1,
wherein the first driving unit comprises a second magnet disposed on the first carrier, a second coil disposed to face the second magnet, and a second position sensor configured to sense a position of the first carrier, and
wherein the second coil includes a third sub-coil and a fourth sub-coil spaced apart from each other in the first-axis direction.

9. The actuator of claim 8, wherein the second position sensor comprises a plurality of hall sensors spaced apart from each other in the first-axis direction.

10. The actuator of claim 8,
wherein the first magnet and the first coil are configured to generate driving force in a direction in which the first magnet and the first coil face each other, and
wherein the second magnet and the second coil are configured to generate driving force in a direction in which the second magnet and the second coil face each other.

11. The actuator of claim 8, further comprising:
a second carrier accommodated in the first carrier; and
an image sensor fixed to the second carrier and comprising an imaging plane,
wherein the first carrier and the second carrier are configured to move together in the first-axis direction and the second-axis direction, and
wherein the second carrier is configured to move relative to the first carrier in an optical-axis direction perpendicular to both the first-axis direction and the second-axis direction.

12. The actuator of claim 11, wherein a first yoke is disposed in the housing to face the first magnet and the second magnet in a direction perpendicular to the imaging plane.

13. The actuator of claim 11, further comprising:
a second driving unit comprising a third magnet disposed in the first carrier and a third coil disposed in the second carrier,
wherein a substrate is disposed in the second carrier, and the third coil is disposed on a surface of the substrate.

14. The actuator of claim 13, wherein the second magnet and the third magnet are disposed between the second coil and the third coil.
